(19) United States
(12) Patent Application Publication
(10) Pub. No.: US 2009/0014112 A1
(43) Pub. Date: Jan. 15, 2009

(54) Termite proof mortar and method of termite proofing a structure

(76) Inventors: Gregory Joseph Evans, New South Wales (AU); George Smorchevsky, New South Wales (AU)

Correspondence Address: PATTERSON, THUENTE, SKAAR & CHRISTENSEN, P.A., 4800 IDS CENTER, 80 SOUTH 8TH STREET, MINNEAPOLIS, MN, 55402-2100, US

(21) Appl. No.: 11/632,769

(22) PCT Filed: Jul. 29, 2005
(86) PCT No.: PCT/AU2005/001125

§ 371 Date: Jun. 29, 2007

(30) Foreign Application Priority Data
Aug. 2, 2004 (AU) 2004904327

(51) Int. Cl. C04B 28/04; E04F 21/18

(52) U.S. Cl. 156/71; 524/2; 524/5; 524/8

(57) ABSTRACT

A method of termite proofing a masonry structure (1) laid on a foundation (3) comprises laying at least a lowermost course of masonry elements (5) forming at least part of the exterior periphery of the structure (1) on the foundation (3) with a layer of termite proof mortar (6) interposed between adjacent masonry elements (5) and between the lowermost course of masonry elements (5) and the foundation (3). Suitable termite proof mortar compositions are also disclosed.

### FIELD OF THE INVENTION

The present invention relates to the control of termites, in particular to methods of termite proofing structures and a termite proof mortar for use in such methods.

### BACKGROUND OF THE INVENTION

A common method of providing protection for buildings and other ground supported structures against termites is by the use of metallic barriers such as stainless steel mesh or aluminium, or by the use of crushed granite and chemical barriers.

Use of these barriers creates a need for a further trade on the job requiring specialised installation techniques, this creates further logistical problems on building sites. The chemicals, also, poison the ground and are typically hazardous to humans, animals and vegetation. The effectiveness of the chemicals also deteriorates over time.

### OBJECT OF THE INVENTION

It is an object of the present invention to overcome or substantially ameliorate at least one of the above disadvantages.

### SUMMARY OF THE INVENTION

The present invention provides a termite proof mortar comprising:

cement;

sand;

polymeric binding agent; and

plasticising agent;

wherein said cement comprises at least 25% of said mortar by mass;

further wherein said polymeric binding agent and said plasticising agent are selected such that:

said mortar is thixotropic; and

said mortar, when mixed with water having a mass of 15% of the mass of said mortar and formed into a disc shape having a diameter of 200 mm and a thickness of 12 mm on a wet, flat, smooth, stainless steel surface, will slip as a substantially single mass from said surface when said surface is inclined at a slip angle to horizontal, said slip angle being between 15 degrees and 45 degrees.

The polymeric binding agent will typically constitute between 1% and 8% of said mortar by mass.

The polymeric binding agent may comprise latex, polyvinylacetate and/or polyvinylether. The polymeric binding agent may alternatively comprise a styrene butyl rubber polymer or copolymer. In another embodiment, the polymeric binding agent comprises a styrene acrylic polymer or copolymer.

Another suitable polymeric binding agent comprises one or more of the group consisting of ethylene, vinyl acetate, vinyl ester and vinyl laurate.

The polymeric binding agent may be in redispersable powder form.

Alternatively, the polymeric binding agent may be in emulsion form.

A single additive may comprise both said polymeric binding agent and said plasticising agent. The single additive may be latex, polyvinylacetate or polyvinylether.

The plasticising agent may comprise an air detrainer.

The air detrainer will typically constitute between 0.05% and 1% of said mortar by mass.

The air detrainer will typically be a surfactant.

The air detrainer may be an alkoxylated hydrocarbon.

Alternatively, the air detrainer may comprise a silicon or oil based surfactant.

The plasticising agent may comprise an air entrainer.

Typically, the air entrainer constitutes no more than 0.1% of said mortar by mass.

The air entrainer will typically be a surfactant.

The air entrainer may be a sulphonated hydrocarbon.

The plasticising agent comprises both an air detrainer and an air entrainer.

In one form, the mortar further comprises a retarding agent.

Typically, the retarding agent constitutes between 0.005% and 0.3% of said mortar by mass.

The retarding agent may comprise a sugar, wood sugar or sugar derivative.

The retarding agent may comprise one or more of the group consisting of sucrose, fructose and glucose.

Alternatively, the retarding agent may comprise a metallic organic salt.

The single additive discussed above may further act as a retarding agent.

In one form, the mortar further comprises a primary expanding agent.

Typically, the primary expanding agent constitutes between 0.0015% and 0.0075% of said mortar by mass.

The primary expanding agent may comprise aluminium powder.

The mortar may further comprise a secondary expanding agent, said secondary expanding agent having a delayed action as compared to said primary expanding agent.

Typically, the secondary expanding agent constitutes between 0.3% and 2% of said mortar by mass.

The secondary expanding agent may comprise calcium sulphoaluminate.

The mortar may further comprise hydrated lime.

The hydrated lime will typically constitute no more than 10% of said mortar by mass.

The cement may constitute at least 30% of said mortar by mass.

The mortar, when cured, typically has a Shore D hardness of at least 70.

In one specific form, the polymeric binding agent comprises styrene butyl rubber copolymer and said plastic agent comprises an air detrainer, said mortar further comprising:

a metallic organic salt;

aluminium powder; and

calcium sulphoaluminate.

There is further disclosed herein a method of termite proofing a masonry structure laid on a foundation, said method comprising laying at least a lowermost course of masonry elements, forming at least part of the exterior periphery of said structure, on said foundation with a layer of termite proof mortar interposed between adjacent masonry elements and between said lowermost course of masonry elements and said foundation.

The foundation may be a concrete slab.

The termite proof mortar will generally extend to at least 75 mm above ground level.

The termite resistant mortar may be as defined above.

The mortar, when cured, typically has a Shore D hardness of at least 70.

In the context of this specification, the term masonry element includes clay bricks, stone blocks, calcium silicate blocks and concrete blocks.

In the context of this specification, measurement of the amount of any mortar constituent by mass is the dry mass for powder constituents, the equivalent dry mass for constituents in liquid suspension/emulsion form, and the mass of active constituent where water or any other non-active substance is added to the active constituent in the commercially used product.

### BRIEF DESCRIPTION OF THE DRAWING

A preferred form of the present invention will now be described by way of example with reference to the accompanying drawing, wherein:

FIG. 1 is a front elevation view of part of a wall of a building.

### DETAILED DESCRIPTION OF THE PREFERRED EMBODIMENTS

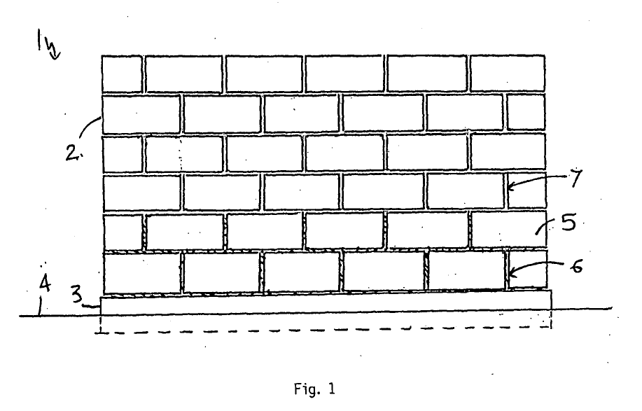

Referring to FIG. 1, a masonry structure in the form of a building 1 is laid on a foundation in the form of a concrete slab 3 formed adjacent to ground level 4. A masonry wall 2 forms part of the exterior periphery of the building 1. The masonry elements 5 of the wall 2 are laid in the usual manner, with the lowermost course of masonry elements 5 being laid on the concrete slab 3, and successive courses of masonry elements 5 being laid on top of each other. The masonry elements may be of any suitable form and construction, including clay bricks, stone blocks, calcium silicate blocks or concrete blocks.

Standard brick mortar, which is typically used when laying such a masonry wall, typically consists of a mixture of six parts of sand, one part cement (generally Portland cement) and one part lime by volume. These volumes are generally measured roughly on site. The lowermost course of masonry elements 5 is typically laid on a bed of such mortar interposed between the concrete slab 3 and the lowermost course of masonry elements 5, with a further layer of mortar interposed between both horizontally and vertically adjacent masonry elements 5. Such mortar is, however, susceptible to intrusion by termites, which remove the sand and eventually penetrate the mortar, allowing access to the interior of the building 1 through the gaps between adjacent masonry elements 5. It is understood by some that excretion of the termites reacts with the free lime in the cement, effectively dissolving the cement and thereby enabling the termites to readily remove the sand. As a result of the susceptibility of standard brick mortar to termite intrusion, the above described mechanical and chemical methods of protecting buildings against termites are used almost exclusively. The present inventors have now established that the termites are able to remove sand from standard brick mortar at least in part as a result of the low hardness of standard brick mortar, which is typically about 55 to 65 on the Shore D scale.

In a preferred embodiment of the present invention, a termite proof mortar 6 is used in place of a standard brick mortar when laying at least the lowermost course of masonry elements 5. Accordingly, a layer of termite proof mortar 6 is interposed between adjacent masonry elements 5 and between the lowermost course of masonry elements 5 and the concrete slab foundation 3. The termite proof mortar 6 would typically be used in the lowermost courses of masonry elements 5 up to at least 75 mm above ground level 4. On a sloping building site it will be typical to lay the masonry elements with the termite proof mortar 6 in as many brick courses 5 as is necessary until the termite proof mortar 6 is at least 75 mm above ground level 4.

With the use of a termite proof mortar 6, the termites are not able to break down the mortar and penetrate through the gaps between adjacent masonry elements or between the lowermost course of masonry elements 5 and the concrete slab foundation 3. The termites will thus be forced to climb up the wall 2 beyond the termite proof mortar to seek a passage into the building 1. Given the aversion of termites to light, the termites will typically build dirt tunnels from ground level up the wall for protection as they climb. Such tunnels are readily visually identifiable and thus provide an early warning of termite activity through visual inspection.

Whilst a termite proof mortar 6 might be utilised for laying masonry elements 5 throughout the entire height of the wall 2, the typically increased cost of a termite proof mortar compared to a standard mortar may dictate that the termite proof mortar is only utilised in the lowermost courses of masonry elements to at least 75 mm above ground level, with a standard mortar 7 being used in the upper courses.

A suitable termite proof mortar comprises cement, sand, polymeric binding agent and plasticising agent. The cement content, which may conveniently be Portland cement, will generally comprise at least 25% of the mortar by mass, and more preferably at least about 30%, so as to provide a high hardness mortar when cured. A suitable termite proof mortar has a Shore D hardness of at least 70 when cured.

The polymeric binding agent increases the bond strength between individual constituents of the mortar, making it more difficult for termites to attack and break down the mortar. The polymeric binding agent also inhibits any potential reaction between excretions of the termite and the available lime in the cement content of the mortar. Further, the polymeric binding agent increases the flexibility of the mortar, thereby reducing the possibility of cracks developing as a result of foundation movements and the like.

The polymeric binding agent will generally constitute between 1% and 8% of the mortar by mass, and typically approximately 2% of the mortar by mass depending upon the particular polymeric binding agent selected and other factors as will be discussed below.

The polymeric binding agent may comprise latex, polyvinylacetate (PVA) and/or polyvinylether (PVE). In the context of this specification, the term latex has its generalised lay meaning utilised in the building trade so as to encompass latex based materials and latex derivatives. PVA or PVE will typically be provided in the form of a powder or emulsion/liquid suspension form. PVA or PVE may be provided dissolved in a suitable solvent. Latex will typically be provided in the form of a powder or liquid suspension. Latex will not dissolve once the mortar has set, even when submerged for extended periods. PVA and PVE may, however, be subject to some softening after setting of the mortar if the mortar becomes wet in some circumstances.

Other suitable polymeric binding agents include styrene butyl rubber polymers and copolymers, styrene acrylic polymers and copolymers, ethylene, vinyl acetate, vinyl ester and vinyl laurate. Two specific suitable styrene butyl rubber copolymers are available under the trade names Acquos Dehydro 7550 and Acquos Dehydro 7552. Several individual polymer binders may be combined if so desired to form the polymeric binding agent.

Given that the various constituents of the mortar may be provided in various forms, with or without the addition of non active substances, such as water, solvents or the like, the mass of each constituent is measured, in the context of this specification, in a dry condition for powder constituents, the equivalent dry mass for constituents in liquid suspension/emulsion, and the mass of active constituent where water or any other non-active substance is added to the active constituent in the commercial product embodying the effective constituent. Measurements are made by mass rather than volume as a result of the small ratios of some of the constituents, discussed below, which do not lend themselves to rough measurement by volume on site when preparing the mortar.

The plasticising agent, sometimes referred to as a workability agent, makes the mortar more workable for the brick layer, making the mix more “fatty”, such that it stands up when spread across the surface of a masonry element or foundation upon which another masonry element is to be laid rather than collapsing as would otherwise be the case. This “fattiness” can be quantified using a sag or slump resistance test. In such a sag resistance test, a volume of mortar is mixed with water in the appropriate proportions and placed in a truncated cone with its base resting on a horizontal surface. The truncated cone is then removed and a measurement is taken as to how far the mortar spreads across the surface over a period of time. A low level of sag/slump is desired.

Bricklayers also desire a mortar to not be too sticky, enabling the brick layer to readily transfer the mixed mortar from the surface of his trowel onto the masonry elements being laid. The bricklayer desires that mixed mortar will remain on his trowel when the trowel blade is held level, transferring the mortar from a bulk supply of mixed mortar to the structure being laid, but then have the mortar readily transfer from the trowel blade as the trowel blade is tilted to transfer the mortar onto the masonry element. The “stickiness” of mortar can generally be quantified by use of a slip resistance test on an angled flow table, measuring at what angle the mortar slips off the flow table. A desirable non-sticky, high slump/sag resistant mortar will slip off the flow table as a single mass with only a small residue left on the flow table. Sticky compositions, such as many cement grouts and adhesives, will tend to gradually spread across the surface (generally at high angles) rather than slip from the surface.

Further, the bricklayer desires that the mortar is thixotropic such that the mortar gradually stiffens when left for a period of time (particularly when laid), but regains its workability when remixed. The thixotropy of the mortar ensures that the mortar won't readily be squeezed out from between masonry elements when a static load of masonry elements of a successive course is laid on top of the mortar, but that remixing of mortar that has been allowed to stand for a period will restore the workability of the mortar. This avoids the need to either discard the mortar or only mix very small batches.

The above-described properties of low stickiness, slump/sag resistance and thixotropy are found in standard bricklayers mortars, and the desired degree of each of these properties varies subjectively between bricklayers. The high cement content and addition of some polymeric binding agents will generally jeopardise these properties, such that the mortar would not have desirable physical properties for the bricklayer laying the mortar. Through selection of appropriate polymeric binding agents and plasticisers, and use of appropriate amounts of these agents, a thixotropic mortar with the appropriate level of stickiness and slump/sag resistance is achievable. Selection of appropriate polymeric binding agents will ensure that the mortar is thixotropic. The level of stickiness and sag resistance may be adjusted as desired through the use of plasticising agents and appropriate selection of polymeric binding agent and quantity thereof.

When large amounts of polymeric binding agent are utilised, or where a particularly sticky binding agent is being utilised, the resulting mortar will be too sticky, requiring the addition of a plasticising agent to reduce the stickiness. A prime reason for the stickiness of the mortar will often be the generation of relatively large air bubbles within the mortar as a result of the polymeric content. These large bubbles are readily collapsed through use of an air detrainer as a plasticising agent. Such an air detrainer may typically constitute between 0.05% and 1% of the mortar by mass, depending upon the level of air detraining required and the specific air detrainer selected. A suitable air detrainer is alkoxylated hydrocarbon, such as is commercially available under the trade name Agitan P845. An alternative suitable air detrainer is a silicon or oil based surfactant.

Whilst large air bubbles are undesirable insofar as the workability of the mortar is concerned, smaller microscopic air bubbles are advantageous, effectively acting as microscopic fluidic ball bearings. A plasticising agent in the form of an air entrainer will create such microscopic bubbles and thus improve the workability of the mixed mortar, reducing its stickiness and improving its sag resistance. An air entrainer may typically constitute up to 0.1% of the mortar by mass, and will generally be in the form of a surfactant. Suitable air entrainers include sulphonated hydrocarbons, such as sodium lauryl sulphate. Another suitable air entrainer is coconut diethanolamide.

It is envisaged that a plasticising agent may include both air detrainers and air entrainers. Air detrainers will likely be utilised more than air entrainers, however when only a small amount of polymeric binding agent is being utilised there may be no need for any air detrainer.

Rather than adding a separate plasticising agent, a single additive may be utilised that performs the functions of both a polymeric binding agent and a plasticising agent.

For example, latex, PVA and PVE each have the properties of such a plasticising agent in addition to being polymeric binding agents, and accordingly one or more of these polymeric binding agents may be utilised without the addition of a separate stand alone plasticising agent if so desired.

The termite proof mortar may further comprise a retarding agent. The retarding agent acts to delay setting of the mortar, increasing the available working time of the mortar for the brick layer. The high cement content of the mortar would otherwise provide a relatively short workingtime. Retarding setting of the mortar also enhances the hardness of the mortar when set, thereby further improving the termite proof characteristics of the mortar. The retarding agent will typically comprise approximately 0.005% to 0.3% of the mortar by mass.

Sugars, sugar derivatives or wood sugars form suitable retarding agents. A sugar retarding agent may particularly be selected from the group consisting of sucrose, fructose and glucose. Another suitable organic retarding agent is starch. Other suitable organic retarding agents include organic metallic salts such as metallic gluconates, heptonates or phosphates. A mixture of organic salts including sodium phosphonate is commercially available under the trade name Delvo Easy 250.

Again rather than adding a stand alone retarding agent, the polymeric binding agent or plasticising agent may be selected so as also to have the properties of a retarding agent, thereby reducing the number of constituents in the mortar. Latex, PVA and PVE generally display the properties of a retarding agent by virtue of the fact that they form a skin on the exterior of the mortar mix, and accordingly lock water content of the mortar into the mix, slowing down internal curing of the mortar.

With the high cement content of the mortar, there is a possibility that shrinkage cracks may develop in the mortar as the mortar shrinks during the curing process. Such shrinkage is generally referred to as primary plastic shrinkage. The primary plastic shrinkage may be exacerbated by dry masonry elements extracting water from the mortar laid against its surface, thereby drying and more rapidly curing the edges of the mortar, resulting in the possibility of cracks running down the centre of the mortar line, potentially allowing termites to intrude. To counter primary plastic shrinkage, a primary expanding agent may be included. The primary expanding agent may typically constitute between 0.0015% and 0.0075% of the mortar by mass. An example of a suitable expanding agent is aluminium powder. The aluminium powder rapidly reacts with water, alkalies and calcium hydroxide in the mortar mix to produce hydrogen bubbles, which results in expansion of the mortar mix.

As well as primary plastic shrinkage, the mortar may be subject to hardened shrinkage, being a secondary form of shrinkage that takes place over a two or three day period immediately following curing of the mortar. Accordingly, a secondary expanding agent may be included as a constituent of the mortar, with the secondary expanding agent having a delayed reaction as compared to the primary expanding agent. The secondary expanding agent may typically constitute between 0.3% and 2% of the mortar by mass. An example of a suitable secondary expanding agent is calcium sulphoaluminate which reacts with the constituents of the mortar to produce expansive calcium sulphoaluminate hydrate and ettringite, however with a delayed onset and extended active period as compared to the early reaction of the aluminium powder.

In many applications, however, the use of expanding agents may not be of any significant benefit, given that one or more successive layers of masonry elements will typically be laid on top of the mortar whilst the mortar is still in a plastic state during the curing process, such that any shrinkage cracks starting to develop will be compressed out by the mass of the masonry elements laid on top of the mortar.

Hydrated lime may also be added to the mortar as desired, depending on the amount of lime in the cement utilised and the properties of the mortar desired. The use of no more than 10% hydrated lime by mass will be typical.

The mortar should be prepared in accordance with the requirements of Australian Standard AS 3700 2001 (Masonry Structures), the entire disclosure of which is incorporated by cross-reference, or an equivalent standard depending upon the country of application. When the mortar constituents are provided in liquid or liquid suspension form, there will typically be no need to add water to the mortar mix, with the water contained within the liquid constituent being sufficient to promote reaction of the mortar constituents. If the constituents are provided in powder form, water will be added to the mortar mix in the usual manner.

A specific example of a suitable termite proof mortar comprises the following constituents measured by approximate mass or mortar:

30% cement;

61.5% silica sand;

6% hydrated lime;

2% styrene butyl rubber copolymer (polymeric binding agent);

0.1% alkoxylated hydrocarbon (plasticising agent);

0.009% sodium phosphonate (retarding agent);

0.0025% aluminium powder (primary expanding agent); and

0.5% calcium sulphoaluminate (secondary expanding agent).

This specific mortar has been tested as having a Shore D hardness of approximately 80.

The slip resistance of this specific mortar was also tested on an angled flow table by mixing a quantity of 3200 grams of the mortar with 500 mls of clean water (constituting approximately 15% of mass of the dry mortar), and forming the mixed mortar into a disc shape having a diameter of 200 mm and a thickness of 12 mm on a wet, flat, smooth stainless steel surface, approximating the surface of a wet bricklaying trowel. The surface was initially held in a horizontal state and gradually inclined until the mortar slipped off the surface. Over a series of tests conducted on a clear day at a room temperature of 21 degrees Celsius, the disc mortar was observed to slip from the surface at an angle of approximately 35 degrees. At all times during the tests, the mortar exhibited no noticeable slump/sag and slid uniformly off the surface as a single mass leaving only a thin film of residue on the surface. Following the conduct of further tests on mortars and grouts having both suitable and unsuitable qualities of stickiness and slump resistance, the present inventors consider that a mortar having a slip angle of between 15 and 45 degrees following the above test, and exhibiting slippage of the mortar from the surface generally as a single mass, will provide suitable physical properties of the mortar rendering it suitable for bricklaying purposes.

The mortar may also be provided with some form of visual identifier, such as a coloured additive, which will assist in visual inspection of the wall 2 to confirm that the termite proof mortar 6 has been utilised correctly in place of a standard mortar.

1-42. (canceled)

43. A termite proof mortar comprising:
cement;
sand;
polymeric binding agent; and
plasticising agent;
wherein said cement comprises at least 25% of said mortar by mass;
further wherein said polymeric binding agent and said plasticising agent are selected such that:
said mortar is thixotropic; and
said mortar, when mixed with water having a mass of 15% of the mass of said mortar and formed into a disc shape having a diameter of 200 mm and a thickness of 12 mm on a wet, flat, smooth, stainless steel surface, will slip as a substantially single mass from said surface when said surface is inclined at a slip angle to horizontal, said slip angle being between 15 degrees and 45 degrees.

44. The mortar of claim 43 wherein said polymeric binding agent constitutes between 1% and 8% of said mortar by mass.

45. The mortar of claim 43 wherein said polymeric binding agent comprises an ingredient selected from the group consisting of latex, polyvinylacetate, polyvinylether, a styrene butyl rubber polymer, styrene butyl rubber copolymer, styrene acrylic polymer, styrene acrylic copolymer, ethylene, vinyl acetate, vinyl ester and vinyl laurate.

46. The mortar of claim 43 wherein said polymeric binding agent is in redispersable powder form.

47. The mortar of claim 43 wherein said polymeric binding agent is in emulsion form.

48. The mortar of claim 43 wherein a single additive comprises both said polymeric binding agent and said plasticising agent.

49. The mortar of claim 48 wherein said single additive is selected from the group consisting of latex, polyvinylacetate and polyvinylether.

50. The mortar of claim 43 wherein said plasticising agent comprises an air detrainer.

51. The mortar of claim 50 wherein said air detrainer is surfactant selected from the group consisting of alkoxylated hydrocarbon, a silicon based surfactant, and an oil based surfactant.

52. The mortar of claim 43 wherein said plasticising agent comprises an air entrainer.

53. The mortar of claim 52 wherein said air entrainer constitutes no more than 0.1% of said mortar by mass.

54. The mortar of claim 43 wherein said plasticising agent comprises an air detrainer and an air entrainer.

55. The mortar of claim 43 further comprising a retarding agent.

56. The mortar of claim 55 wherein said retarding agent is selected from the group consisting of a sugar, wood sugar, sugar derivative, and an organic metallic salt.

57. The mortar of claim 48 wherein said single additive further acts as a retarding agent.

58. The mortar of claim 43 further comprising a primary expanding agent.

59. The mortar of claim 58 wherein said primary expanding agent comprises aluminium powder.

60. The mortar of claim 58 further comprising a secondary expanding agent, said secondary expanding agent having a delayed action as compared to said primary expanding agent.

61. The mortar of claim 60 wherein said secondary expanding agent comprises calcium sulphoaluminate.

62. The mortar of claim 43 further comprising hydrated lime.

63. The mortar of claim 43 wherein said cement constitutes at least 30% of said mortar by mass.

64. The mortar of claim 43 wherein said mortar, when cured, has a Shore D hardness of at least 70.

65. The mortar of claim 43 wherein said polymeric binding agent comprises styrene butyl rubber copolymer and said plastic agent comprises an air detrainer, said mortar further comprising:
a metallic organic salt;
aluminium powder; and
calcium sulfoaluminate.

66-68. (canceled)

69. A method of termite proofing a masonry structure laid on a foundation, said method comprising laying at least a lowermost course of masonry elements, forming at least part of the exterior periphery of said structure, on said foundation with a layer of termite proof mortar interposed between adjacent masonry elements and between said lowermost course of masonry elements and said foundation.

70. The method of claim 69 wherein said foundation is a concrete slab.

71. The method of claim 69 wherein said termite proof mortar extends to at least 75 mm above ground level.

72. The method of claim 69 wherein said termite proof mortar comprises cement;
sand;
polymeric binding agent; and
plasticising agent;
wherein said cement comprises at least 25% of said mortar by mass;
further wherein said polymeric binding agent and said plasticising agent are selected such that:
said mortar is thixotropic; and
said mortar, when mixed with water having a mass of 15% of the mass of said mortar and formed into a disc shape having a diameter of 200 mm and a thickness of 12 mm on a wet, flat, smooth, stainless steel surface, will slip as a substantially single mass from said surface when said surface is inclined at a slip angle to horizontal, said slip angle being between 15 degrees and 45 degrees.

73. The method of claim 69 wherein said termite proof mortar, when cured, has a Shore D hardness of at least 70.
